(19) United States
(12) Patent Application Publication
(10) Pub. No.: US 2008/0191579 A1
(43) Pub. Date: Aug. 14, 2008

(54) STATOR OF MOTOR AND MANUFACTURING METHOD THEREOF

(76) Inventors: Shen-Hua LUO, Taoyuan Hsien (TW); Tien-Huei Su, Taoyuan-Hsien (TW)

Correspondence Address: BIRCH STEWART KOLASCH & BIRCH, PO BOX 747, FALLS CHURCH, VA, 22040-0747, US

(21) Appl. No.: 12/018,390

(22) Filed: Jan. 23, 2008

(30) Foreign Application Priority Data
Feb. 14, 2007 (TW) 096105412

(51) Int. Cl. H02K 1/12; H02K 15/02

(52) U.S. Cl. 310/254; 29/596

(57) ABSTRACT

A manufacturing method of a stator of a motor includes steps of providing a silicon steel sheet set, which includes a plurality of tightly stacked silicon steel sheets; disposing the silicon steel sheet set in a single mold; infusing a molding material into the mold and solidifying the molding material to tightly cover and combine with the silicon steel sheet set. A stator of motor fabricated by the manufacturing method is also disclosed.

### CROSS REFERENCE TO RELATED APPLICATIONS

This Non-provisional application claims priority under 35 U.S.C. §119(a) on Patent Application No(s). 096105412 filed in Taiwan, Republic of China on Feb. 14, 2007, the entire contents of which are hereby incorporated by reference.

### BACKGROUND OF THE INVENTION

1. Field of Invention

The invention relates to a stator of a motor and a manufacturing method thereof and in particular to a stator of a motor and a manufacturing method thereof which can avoid assembling error.

2. Related Art

Motors, which can convert electric energy to mechanical energy according to the theory of electromagnetic induction, are widely used in the mechanisms, such as fans, CD-ROM drivers or hard disk drivers. In general, a motor includes a rotor and a stator. The magnetic fields reaction between the rotor and stator can drive the rotor to rotate with respect to the stator.

As shown in FIG. 1, a conventional stator 1 includes an upper cover 11, a lower cover 12 and a silicon steel sheet set 13. The silicon steel sheet set 13 includes a plurality of silicon steel sheets 131 which are stacked tightly. For manufacturing the stator 1, two separated molds for respectively manufacturing the upper cover 11 and the lower cover 12 are needed. That is, the molding materials must be injected into the molds to make the upper cover 11 and the lower cover 12, respectively. The upper cover 11 and the lower cover 12 are then assembled at the top surface 132 and the bottom surface 133 of the silicon steel sheet set 13 manually, and then the coil is wound on the assembled upper cover 11, lower cover 12 and silicon steel sheet set 13.

Because the upper cover 11 and the lower cover 12 axe made by two molds, two or more injection machines axe needed for one production line to produce the upper cover 11 and the bottom cover 12. In addition, all components of the stator 1 must be stored in warehouses after they are initially produced. During the following assembling process, the stored components are delivered to the production line for assembling. Therefore, the manufacturing procedures become more complex and the production cost is increased. Furthermore, the insulating paint of the coil in the later winding process is easy to be peeled off by the ragged edges of the upper cover 11 and the bottom cover 12. Moreover, the upper cover 11 and the lower cover 12 may be deformed, resulting in that the upper cover 11, lower cover 12 and the silicon steel sheet set 13 can not connected tightly. This causes the problems of crossing wires and poor pressure durability.

### SUMMARY OF THE INVENTION

In view of the foregoing, the present invention is to provide a stator of a motor and a manufacturing method thereof that can simplify the manufacturing process, decrease the production cost and assembling cost, avoid complex processes and enhance the reliability and production yield.

To achieve the above, the present invention discloses a manufacturing method of a stator of a motor. The manufacturing method includes the following steps of: providing a silicon steel sheet set, which includes a plurality of tightly stacked silicon steel sheets; disposing the silicon steel sheet set in a mold; infusing a molding material or plastic into the mold; and solidifying the molding material so that the molding material tightly covers the silicon steel sheet set.

In addition, the present invention also discloses a stator of a motor including a silicon steel sheet set, an upper cover and a lower cover. The silicon steel sheet set includes a plurality of silicon steel sheets that are tightly stacked. The upper cover covers a top surface of the silicon steel sheet set. The lower cover covers a bottom surface of the silicon steel sheet set. The upper cover and the lower cover are molded by a single mold to tightly cover the silicon steel sheet set.

As mentioned above, the upper cover and the lower cover of the present invention are molded by a single mold to cover the silicon steel sheet set. Compared with the prior art, the upper cover and the lower cover are simultaneously molded and then solidified to tightly cover the silicon steel sheet set. Hence, the present invention can simplify manufacturing process, decrease production cost and assembling cost, avoid complex processes and enhance reliability and production yield.

### BRIEF DESCRIPTION OF THE DRAWINGS

The present invention will become more fully understood from the detailed description and accompanying drawings, which are given for illustration only, and thus are not limitative of the present invention, and wherein:

FIG. 1 is an exploded view of a conventional stator;

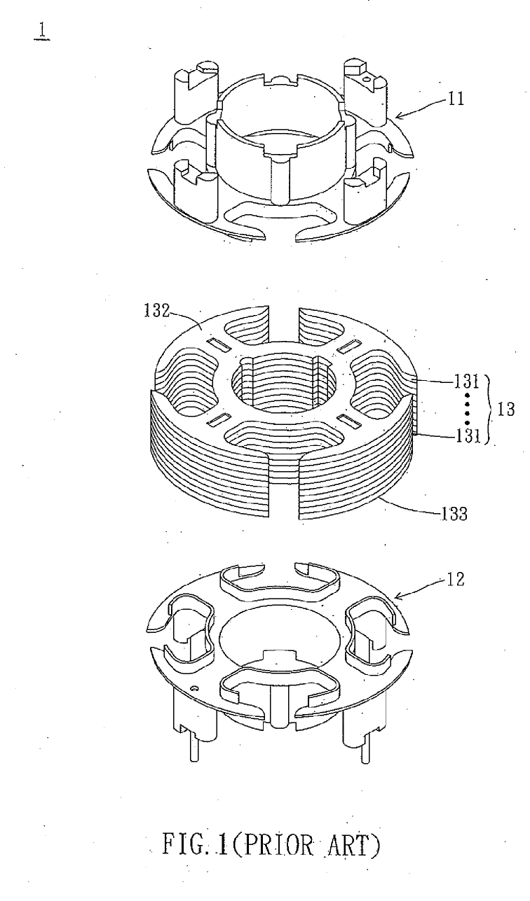

FIG. 2 is a schematic illustration of a mold for manufacturing a stator according to an embodiment of the present invention;

FIG. 3 is a schematic illustration showing a stator of a motor according to the embodiment of the present invention; and

FIG. 4 is a flow chart of a manufacturing method of a stator according to the embodiment of the present invention.

### DETAILED DESCRIPTION OF THE INVENTION

The present invention will be apparent from the following detailed description, which proceeds with reference to the accompanying drawings, wherein the same references relate to the same elements.

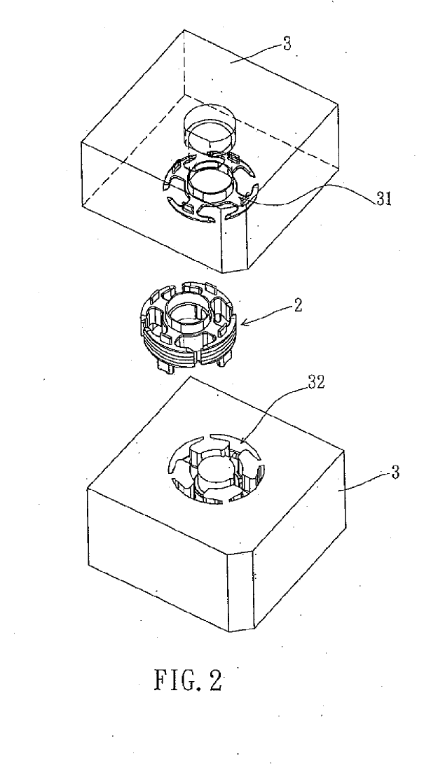

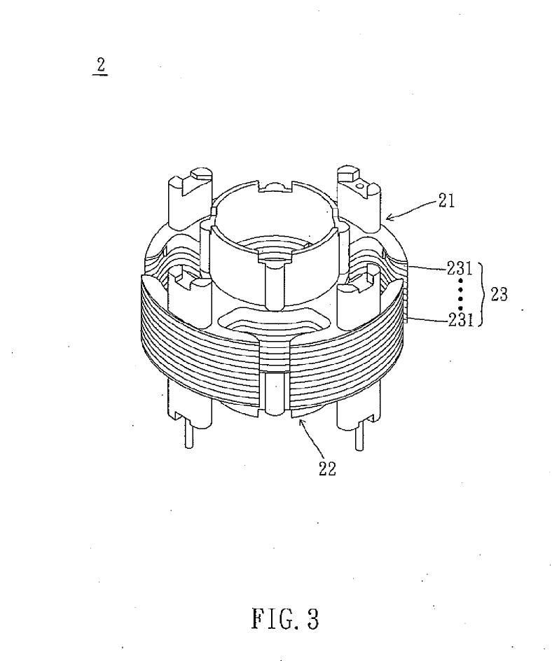

As shown in FIGS. 2 and 3, a stator 2 according to an embodiment of the present invention includes an upper cover 21, a lower cover 22 and a silicon steel sheet set 23. The silicon steel sheet set 23 includes several silicon steel sheets, which are tightly stacked. The upper cover 21 covers the top surface of the silicon steel sheet set 23, and the lower cover 22 covers the bottom surface of the silicon steel sheet set 23. The upper cover 21 and the lower cover 22 are molded by a single mold 3 to directly and tightly cover the silicon steel sheet set 23.

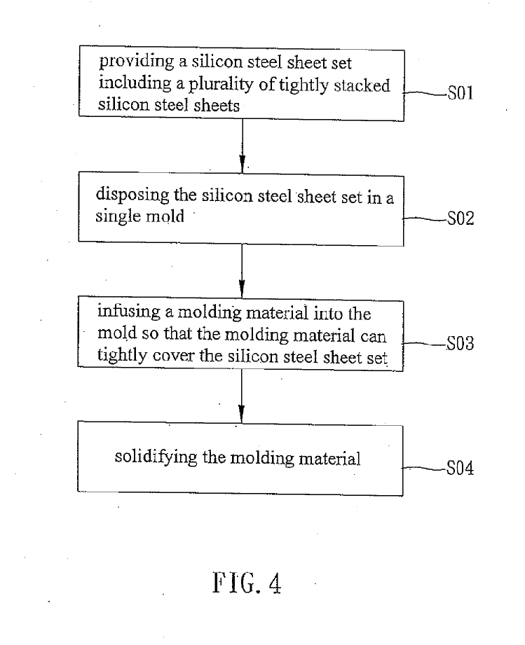

As shown in FIGS. 2 and 4, a manufacturing method of the stator 2 according to the embodiment of the present invention includes the steps S01 to S03. The step S01 is to provide a silicon steel sheet set 23, which includes a plurality of tightly stacked silicon steel sheets 231. The step S02 is to dispose the silicon steel sheet set 23 into an upper mold cavity 31 or a lower mold cavity 32 of a single mold 3. The step S03 is to infuse a molding material into the mold 3 so that the molding material can tightly cover the silicon steel sheet set 23 after the mold 3 is closed.

In the embodiment, the upper mold cavity 31 and the lower mold cavity 32 of the mold 3 are designed according to the combination structure of the silicon steel sheet set 23, the upper cover 21 and the lower cover 22. In addition, the molding material to be infused can be a plastic material, such as cold-setting material, thermosetting material or photo-curing material. The molding material can tightly cover the silicon steel sheet set 23 by a way of injection molding.

After the molding material tightly covers the silicon steel sheet set 23, the manufacturing method further includes a step S04 to solidify the molding material. Depending on the type of the molding material, the method of solidifying the molding material can be cold setting, thermosetting or photo curing, for example. After being solidified, the molding material becomes the upper cover 21 and the lower cover 22. Consequently, the upper cover 21 and the lower cover 22 are directly molded to tightly cover the silicon steel sheet set 23. Accordingly, the upper cover 21, the lower cover 22 and the silicon steel sheet set 23 of the embodiment have a tight connection, thereby making the following winding process easier and avoiding the problems of crossing wires and poor pressure durability.

In summary, the upper cover and the lower cover of the present invention are molded by a single mold to cover the silicon steel sheet set. Compared with the prior art, the production cost can be lowered because only a single mold is used. Furthermore, the upper cover and the lower cover are simultaneously molded to tightly and directly cover the silicon steel sheet set. Hence, the present invention can simplify manufacturing process, decrease the time and cost of manual assembling, avoid conventional complex processes and enhance reliability and the production.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A manufacturing method of a stator of a motor, comprising steps of:
providing a silicon steel sheet set comprising a plurality of tightly stacked silicon steel sheets;
disposing the silicon steel sheet set into a single mold;
infusing a molding material into the mold; and
solidifying the molding material so as to combine the molding material with the silicon steel sheet set.

2. The manufacturing method as recited in claim 1, wherein the molding material is infused by a way of injection molding.

3. The manufacturing method as recited in claim 1, wherein the molding material is solidified by a way of cold setting, thermosetting or photo curing.

4. The manufacturing method as recited in claim 1, wherein the molding material tightly covers the silicon steel sheet set.

5. The manufacturing method as recited in claim 1, wherein the molding material is infused to cover a top side and a bottom side of the silicon steel sheet set.

6. The manufacturing method as recited in claim 1, wherein the molding material is solidified to form an upper cover and a lower cover of the stator.

7. The manufacturing method as recited in claim 6, wherein a mold cavity of the mold is corresponding to a combination structure of the silicon steel sheet set, the upper cover and the lower cover.

8. A stator of a motor, comprising:
a silicon steel sheet set comprising a plurality of tightly stacked silicon steel sheets;
an upper cover covering a top surface of the silicon steel sheet set; and
a lower cover covering a bottom surface of the silicon steel sheet set;
wherein the upper cover and the lower cover are directly formed by a single mold to tightly cover the silicon steel sheet set.

9. The stator as recited in claim 8, wherein the upper cover and the lower cover are directly molded by a way of injection molding.

10. The stator as recited in claim 8, wherein the upper cover and the lower cover comprise a molding material.

11. The stator as recited in claim 10, wherein the molding material comprises a cold-setting plastic, a thermosetting plastic or a photo-curing plastic.

12. The stator as recited in claim 8, wherein the upper cover and the lower cover are simultaneously formed to tightly cover the silicon steel sheet set.

13. The stator as recited in claim 8, wherein a mold cavity of the mold is corresponding to a combination structure of the silicon steel sheet set, the upper cover and the lower cover.
